(19) United States
(12) Patent Application Publication
(10) Pub. No.: US 2013/0255277 A1
(43) Pub. Date: Oct. 3, 2013

(54) GAS TURBINE ENGINE NOSE CONE

(71) Applicants: Enzo Macchia, Kleinburg (CA); Andreas Eleftheriou, Woodbridge (CA); Thomas Peter McDonough, Barrie (CA); George Guglielmin, Toronto (CA); Joe Lanzino, Orangeville (CA); Barry Barnett, Markham (CA)

(72) Inventors: Enzo Macchia, Kleinburg (CA); Andreas Eleftheriou, Woodbridge (CA); Thomas Peter McDonough, Barrie (CA); George Guglielmin, Toronto (CA); Joe Lanzino, Orangeville (CA); Barry Barnett, Markham (CA)

(21) Appl. No.: 13/435,738

(22) Filed: Mar. 30, 2012

(51) Int. Cl. F02C 7/00; F02C 3/04; B05D 1/18; F01D 25/00

(52) U.S. Cl. 60/805; 416/245 R; 427/436

(57) ABSTRACT

A nose cone for a turbofan gas turbine engine includes a central tip, an outer perimeter and a substantially conical outer wall extending therebetween which encloses a cavity therewithin. The outer wall includes an inner substrate layer facing the cavity and an outer layer which overlies and at least partially encloses the inner substrate layer. The outer layer is composed entirely of a nanocrystalline metal forming an outer surface of the nose cone.

### TECHNICAL FIELD

The present disclosure relates generally to nose cones for turbofan gas turbine engines.

### BACKGROUND

Turbofan gas turbine engines include a nose cone at the center of the upstream fan, which rotates with the fan rotor and generally acts to help guide air into the engine while also serving to help protect the engine core from the elements, foreign object damage, etc. Typically, such nose cones are composed of a metal. However, such known nose cones for turbofan gas turbine engines tend to be relatively heavy, relatively expensive to produce, and may be prone to erosion and/or other wear.

Increasing demands for lower weight components used in aero gas turbine engines have led to an increasing use of carbon fibre composite products and other non-metal components. However, FOD (foreign object damage) resistance, including to ice projectiles and bird strikes, for example, as well as erosion resistance for carbon composite components, remains a concern for such components, especially when the components are intended for the fan region of the engine, which is the most exposed and thus prone to such damage.

### SUMMARY

There is therefore provided a nose cone for a turbofan gas turbine engine, the nose cone comprising a central tip, an outer perimeter and a substantially conical outer wall extending therebetween which encloses a cavity therewithin, the outer wall including an inner substrate layer facing the cavity and an outer layer which overlies and at least partially encloses the inner substrate layer, the outer layer being composed entirely of a nanocrystalline metal forming an outer surface of the nose cone.

Further, there is provided a fan assembly for a gas turbine engine comprising a plurality of fan blades substantially radially extending from a fan disk adapted to be mounted to a main engine shaft, and a nose cone mounted to the fan disk, the nose cone being as defined in the paragraph above.

There is also provided a turbofan gas turbine engine comprising a fan assembly, an engine core including a compressor section, a combustor and a turbine section in serial flow communication, at least one low pressure compressor of the compressor section and at least one low pressure turbine of the turbine section being mounted to a common engine low pressure shaft, the fan assembly including a plurality of fan blades substantially radially extending from a fan disk mounted to the engine low pressure shaft and a nose cone mounted to the fan disk for rotation therewith, the nose cone having a central tip, an outer perimeter and a substantially conical outer wall extending therebetween which encloses a cavity therewithin, the outer wall including an inner substrate layer facing the cavity and an outer layer which overlies and at least partially encloses the inner substrate layer, the outer layer being composed entirely of a nanocrystalline metal forming an outer surface of the nose cone.

There is further provided a method of manufacturing a nose cone for a gas turbine engine, the method comprising the steps of: providing an outer wall of the nose cone composed of an inner substrate layer formed of a first material; and applying a nanocrystalline metal coating over at least a portion of the inner substrate layer of the outer wall of the nose cone, the nanocrystalline metal coating forming an outer surface of the nose cone.

### BRIEF DESCRIPTION OF THE DRAWINGS

Reference is now made to the accompanying figures in which:

FIG. 1 is a schematic cross-sectional view of a turbofan gas turbine engine;

FIG. 2 is a perspective view of a nose cone for use in a gas turbine engine such as that shown in FIG. 1;

FIG. 3 is a cross-sectional view of the nose cone of FIG. 2;

FIG. 4 is an enlarged, detailed cross-sectional view of the nose cone, taken from region 4 of FIG. 3; and

FIG. 5 is a partial cross-sectional view of an alternate nose cone which can be used in the gas turbine engine of FIG. 1

### DETAILED DESCRIPTION

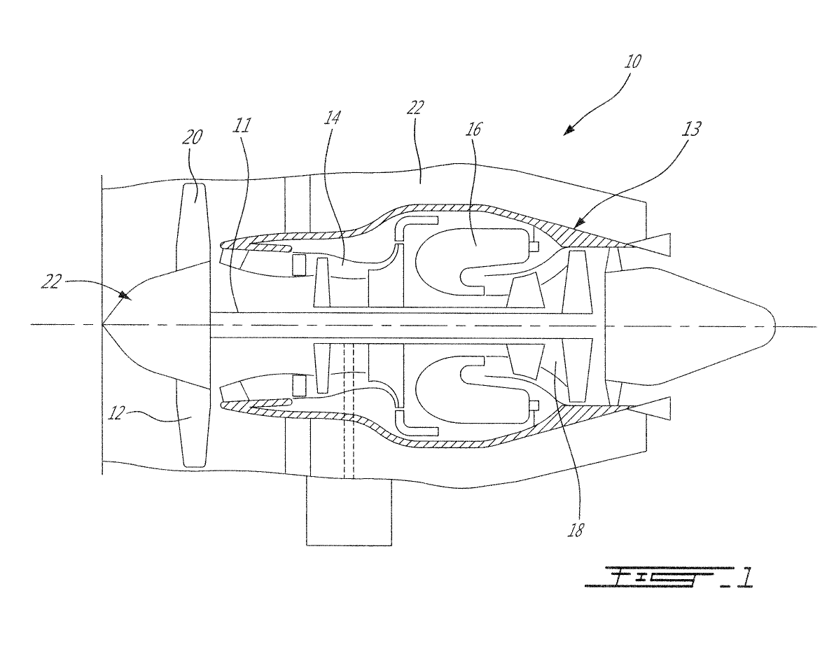

FIG. 1 illustrates a turbofan gas turbine engine 10 generally comprising in serial flow communication, a fan assembly 12 through which ambient air is propelled, and a core 13 including a compressor section 14 for pressurizing the air, a combustor 16 in which the compressed air is mixed with fuel and ignited for generating an annular stream of hot combustion gases, and a turbine section 18 for extracting energy from the combustion gases.

The fan 12 propels air through both the engine core 13 and the bypass duct 22, and may be mounted to the low pressure main engine shaft 11. The fan 12 includes a plurality of radially extending fan blades 20 and a central nose cone, or “spinner”, 22. The fan 12 may include a central rotor hub or disk (not shown), which is protected by the nose cone 22 and to which the fan blades 20 are mounted. Alternately, the fan 12 may be an integrally bladed rotor (IBR), in which case the fan blades 20 are integrally formed with the central hub or disk that is fastened to the low pressure (LP) engine shaft 11 for rotation therewith.

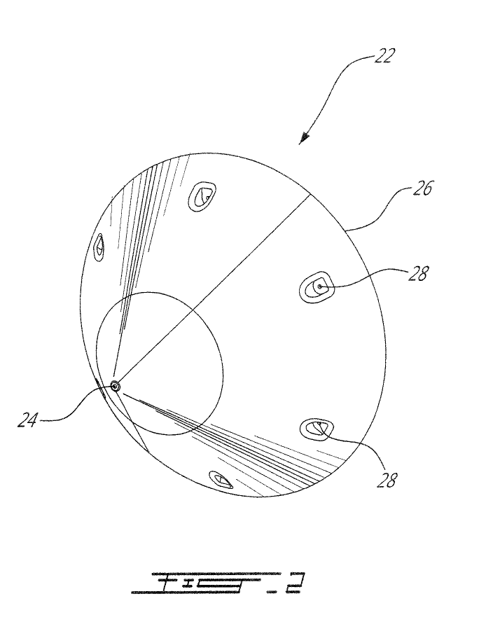

Referring now to FIGS. 2 to 4, the nose cone 22 of the fan assembly 12 of the turbofan gas turbine engine 10 is shown in isolation, i.e. detached from the fan disk and/or the rest of the fan assembly 12. As can be seen, the nose cone 12 has a generally conical shape, and defines a central tip 24 and a circular outer perimeter 26. A plurality of fastening points 28 are provided near the circular outer perimeter 26, the fastening points 28 being used to fasten the nose cone 22 in place on the fan disk or hub portion of the fan 12.

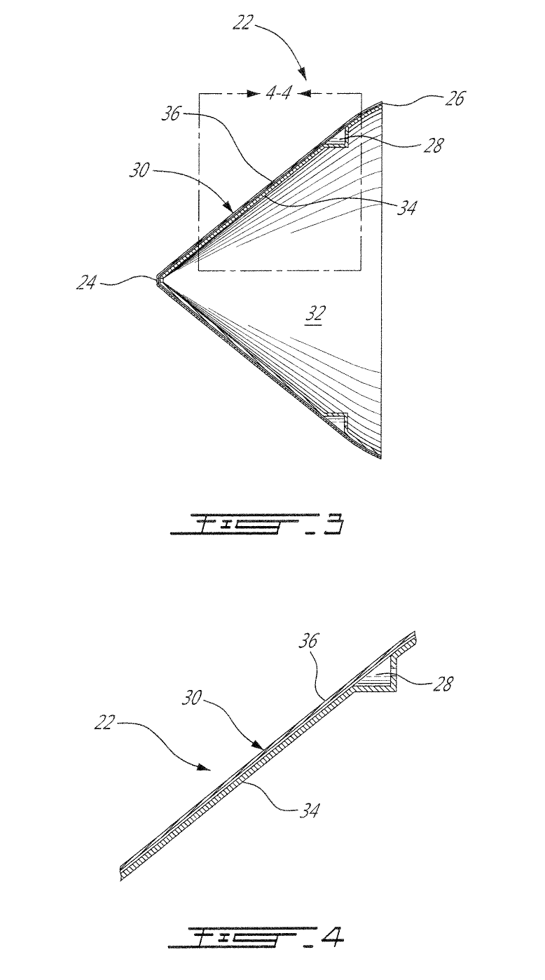

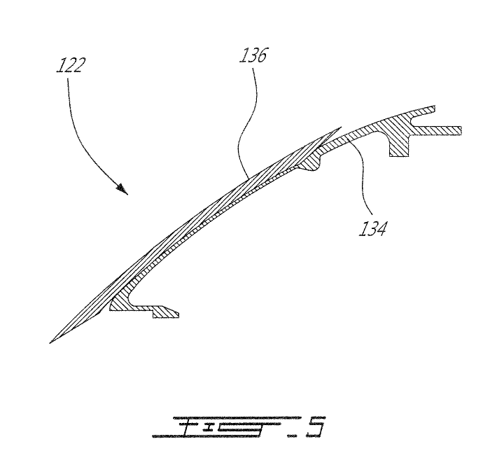

As seen in FIGS. 3-4, the nose cone 22 is, in at least one particular embodiment, generally hollow and includes an outer wall 30, extending between the central tip 24 and the circular outer perimeter 26 and which may be frusto-conical in shape. Other configurations and/or shapes of the outer wall 30 may also be possible. The outer wall 30 of the nose cone 22 defines therewithin a cavity 32 within the nose cone 22. The outer wall 30 of the nose cone 22 includes a double-layer construction comprised of an inner substrate layer 34, facing the cavity 32, and an outer layer 36 which overlies the substrate layer 34 and provides the outer surface of the nose cone 22. The nose cone 22 is thus hollow and includes a relatively thin-walled, dual layer configuration formed by the superposed inner and outer layers 34, 36 of the outer wall 30 thereof. Accordingly, the nose cone 22 is formed having a hybrid, or bi-layer, construction, in which the frusto-conical wall 30 is formed of two distinct layers, namely the inner and outer layers 34, 36. As will be seen, at least one of the inner and outer layers 34, 36 of the wall 30 of the hollow nose cone 22 comprises a nanocrystalline metal, either partially or fully, which helps make the nose cone 22 relatively strong yet light, while further being relatively cost effective to manufacture. Particularly, although not necessarily, the outer layer 36 of the wall 30 of the nose cone 22 is a nanocrystalline coating, as will be described in further detail below, which is applied to the underlying substrate of the inner layer 34.

In one possible embodiment of the present disclosure, the inner layer 34 of the frusto-conical wall 30 of the nose cone 22 is made of a metal and/or metal alloy, such as aluminum for example, upon which the outer nanocrystalline coating is applied to form the outer layer 36. The outer layer 36, in this embodiment, is thus composed of a nanocrystalline (nano-grained) metal which is applied, by plating or otherwise, as a thin (ex: 4-5 thousandths of an inch) coating onto the underlying aluminum of the inner layer 34. As such, in this embodiment the two layers 34, 36 are composed of different materials, with the outer layer 36 being a nanocrystalline coating and the underlying inner layer 34 being a metal, such as but not necessarily aluminum.

While known prior art nose cones are often made of aluminum, by using the bi-layer, and bi-material, construction of the nose cone 22, the inner substrate layer 34 made of aluminum can be much thinner than those of the prior art, due to the added strength provided by the outer nanocrystalline coating. A savings of up to 50% of the aluminum weight typically used in prior art aluminum nose cones can thus be achieved. For example, the inner substrate layer 34 made of aluminum may weight 1.5 lbs, relative to the 3 lbs of aluminum which is often used in prior art aluminum nose cones. Even allowing for a small amount of added weight due to the thin nanocrystalline metal coating 36 applied thereof, a substantial overall weight savings is achieved. The added strength provided by the nanocrystalline metal coating forming the outer layer 36 therefore allows the underlying aluminum forming the inner layer 34 to be relatively thinner, and thus lighter weight and less costly to manufacture. While aluminum is described above as the exemplary metal forming the inner substrate layer 34 upon which the nanocrystalline metal coating 36 is applied, it is to be understood that other metals, metal alloys, and the like can be used to form the underlying inner metal layer 34 upon which the nanocrystalline coating 36 is applied.

In another embodiment, similar to that described above, the inner layer 34 is formed from a non-metallic material, such as but not limited to, polymers, composites, plastics, etc. As such, the inner layer 34 of the wall 30 forming the nose cone 22 may be formed of a composite, polymer, plastic or other non-metallic substrate, upon which the nanocrystalline metal topcoat layer 36 is applied to at least partially, if not fully, enveloped the non-metallic substrate layer 34. This embodiment is particularly useful because of the ease of manufacturing with which the non-metallic substrate layer 34 may be produced, which results in lower production times and manufacturing costs for the nose cone 22. For example, a nose cone having a relatively complex shape, which may be difficult or overly expensive to machine from a metal blank, may be much more easily produced out of composite, plastic or a polymer material, for example. Once this complex non-metallic nose cone shape is produced, it may then be coated with the nanocrystalline metal to provide it with the strength required for use on the turbofan engine 10.

In yet another related embodiment, the inner layer 34 is formed of metallic foam, which may itself be comprised of a nano-grain metal as to form a “nanocrystalline metal foam which makes up the inner substrate layer 34, upon which the above-mentioned nanocrystalline metal outer coating 36 is applied. In this case, clearly, the two layers 34, 36 may be formed of the same or similar nano-gain sized materials. However, the structure of each differs in this case, whereby the inner substrate layer 34 is thicker and comprised of a nano-metal foam structure while the outer layer is a thin plated coating formed of solid nano-metal.

The use of the nanocrystalline metal coating to form the outer layer 36 on the nose cone 22 also allows for additional advantages. In one or more of the above-mentioned embodiments, wherever the geometry permits, the nanocrystalline metal coating making up the outermost surface of the outer layer 36 is contoured in order to reduce the tension angle on the surface of the nose cone, thereby making the outermost surface of the nose cone 22 a “non-wetting” or “hydrophobic” surface. The surface contours or roughness formed in and/or by the outmost surface of the nanocrystalline layer 36 thus has a much lower surface tension than the perfectly smooth surfaces of prior art nose cones, which thus causes the formation of circular non-wetting water droplets on the surface, which then cannot readily stick to the non-wetting surface. This helps prevent the build up of ice on the outer surface of the nose cone 22, thereby resulting in a non-icing (or anti-icing) surface. The surface contour shaping in the nanocrystalline metal coating forming the outer layer 36 of the nose cone 22 may be achieved by either moulding the surface of the nose cone with appropriate surface features or adding an additional, external, surface layer onto the main outer surface of the outer layer 36. Such an additional, external, surface layer may, for example, be formed of a plastic, a nanocrystalline metal, or other suitable material, and may have the necessary surface features directly incorporated therein.

The aforementioned non-wetting or hydrophobic outer surface which is thus created in and/or by the nanocrystalline coating of the outer layer 36 accordingly helps prevent the build up of ice, dirt and/or other debris on the nose cone 22. The hydrophobic outer surface of the nanocrystalline metal outer layer 36 of the nose cone 22 prevents ice from building up on the nose cone during flight, and may further avoid the need for any additional anti-icing of the nose cone. Conventionally, in known nose cone assemblies of the prior art, hot air is bled off from the main engine and fed into the hollow cavity within the nose cone in order to keep the nose cone warm and thus prevent any build up of ice on the outer surface of the nose cone. With the presently described nose cone 22, hot air is not required to be provided within the cavity 32 of the nose cone in order to ensure that ice will not build up on the outer surfaces thereof, because the hydrophobic outer surface on the nanocrystalline outer surface 36 prevents, without additional heat transfer assistance, ice from being able to form a and/or accumulate on the outer surface of the nose cone 22. As such, performance improvements (ex: improved specific fuel consumption) can be achieved by avoiding the need to bleed off any warm air from the main core of the engine, which would otherwise negatively effect engine performance and thus fuel consumption.

Further still, the surface texture of the aforementioned hydrophobic outer surface which is thus created in and/or by the nanocrystalline coating of the outer layer 36 of the nose cone 22 also helps to achieve performance improvements for the fan 20 and thus the turbofan engine 10. The surface features or surface texture thus created can be adjusted or modified as required, depending for example on the engine, expected environmental conditions, etc. This surface texture on the nanocrystalline outer layer 36 of the nose cone 22 creates an inherent lubricity of the nose cone's outermost surface, which causes the boundary layers that form in the free air stream over the nose cone 22 when the engine 10 is in flight to be reduced, thereby reducing the aerodynamic drag produced by the nose cone 22 itself. This reduction in drag may consequently reduce the specific fuel consumption of the engine.

Any reduction in fuel consumption which can be achieved remains very desirable in aero gas turbine engine applications. The surface texture of the aforementioned hydrophobic outer surface which is created in and/or by the nanocrystalline coating of the outer layer 36 of the nose cone 22 therefore provides improved fuel consumption both by preventing the need for additional engine bleed anti-icing and by reducing the drag produced by the nose cone.

Referring now to FIG. 5, an alternate nose cone 122 includes an inner nose cone layer 134 which forms the structural base of the nose cone, to which an outer layer or plate 136 is attached. The nose cone 122 may have the same properties and structural configurations as the nose cone 22 described above, however the outer layer 136 is in fact a separately formed plate component that this fastened to the underlying base structure 134 of the nose cone 122. The outer plate component 136 is nevertheless comprised of a nanocrystalline metal, whether it be entirely nano-metal or have a base structure which is itself then coated with a thin nano-metal coating.

The outer layer of the nose cones described above are composed by a nanocrystalline metal (i.e. a nano-metal coating having a nano-scale crystalline structure), as will now be described in further detail. Although the nanocrystalline metal coating which forms the outer layer of the nose cone will be hereinafter described in further detail with respect to the nose cone 22 embodiment of FIGS. 2-4, it is to be understood that the following details apply to any and all embodiments.

The nanocrystalline metal coating 36 of the nose cone 22 may be formed from a pure metal, as noted further below, in an alternate embodiment the nanocrystalline metal layer may also be composed of an alloy of one or more of the metals mentioned herein. Further, although multiple coats of the nanocrystalline metal may be applied to the inner layer 34 of the nose cone 22 if desired and/or necessary, in a particular embodiment the a single layer of the outer nano-metal coating.

The nose cone 22 therefore includes a single layer topcoat 36 of a nano-scale, tine grained metal which substantially entirely covers the exposed outer surfaces of the nose cone, as illustrated in FIG. 3 with an exaggerated relative thickness for clarity. The nano-metal coating may be pure, which is understood to include a metal comprising trace elements of other components. As such, in a particular embodiment, the nanocrystalline metal coating which forms the outer layer 36 of the nose cone 22 is composed of a substantially pure Nickel coating, which may have trace elements such as but not limited to: C=200 parts per million (ppm), S<500 ppm, Co=10 ppm, O=100 ppm.

In a particular embodiment, the nanocrystalline metal coating which forms the outer layer 36 of the nose cone and is applied directly to the underlying inner layer 34, for example by using a plating process for example. Other types of bonding can also be used, and may include: surface activation, surface texturing, applied resin and surface grooves or other shaping. In another example, described in more detail in U.S. Pat. No. 7,591,745, which is incorporated herein, a layer of conductive material is additionally employed between the substrate layer 34 and nanocrystalline topcoat layer 36 to improve adhesion and the coating process. In this alternate embodiment, an intermediate bond coat is first disposed on the inner layer 34 before the nanocrystalline metallic topcoat 36 is applied over the outer surfaces of the outer wall 30 of the nose cone 22. This intermediate bond coat may improve adhesion between the nanocrystalline metal coating 36 and the inner substrate layer 34, and therefore improve the coating process, the bond strength and/or the structural performance of the nanocrystalline metal coating 36 that is bonded to the inner substrate layer 34.

The nanocrystalline metal top coat layer 36 has a tine grain size, which provides improved structural properties of the nose cone 22. The nanocrystalline metal coating is a fine-grained metal, having an average grain size at least in the range of between 1 nm and 5000 nm. In a particular embodiment, the nanocrystalline metal coating has an average grain size of between about 10 nm and about 500 nm. More particularly, in another embodiment the nanocrystalline metal coating has an average grain size of between 10 nm and 50 nm, and more particularly still an average grain size of between 10 nm and 15 nm. The thickness of the single layer nanocrystalline metal topcoat 36 may range from about 0.001 inch (0.0254 mm) to about 0.125 inch (3.175 mm), however in a particular embodiment the single layer nano-metal topcoat 36 has a thickness of between 0.001 inch (0.0254 mm) and 0.008 inches (0.2032 mm). In another more particular embodiment, the nanocrystalline metal topcoat 36 has a thickness of about 0.005 inches (0.127 mm). The thickness of the topcoat 36 may also be tuned (i.e. modified in specific regions thereof, as required) to provide a structurally optimum part. For example, the nanocrystalline metal topcoat 36 may be formed thicker in expected weaker regions of the nose cone 22, such as at the attachment points 28 for example, and thinner in other regions which may be structurally stronger due simply to geometry or other factors. The thickness of the nano-metallic topcoat 36 may therefore not be uniform throughout the nose cone 22.

Alternately, of course, the outer nanocrystalline metal layer 35 may fully encapsulate the inner layer 34, and may also be provided with the coating having a uniform thickness (i.e. a full uniform coating) throughout.

The nanocrystalline metal topcoat 36 may be a pure metal such one selected from the group consisting of: Ag, Al, Au, Co, Cu, Cr, Sn, Fe, Mo, Ni, Pt, Ti, W, Zn and Zr, and is purposely pure (i.e. not alloyed with other elements) to obtain specific material properties sought herein. The manipulation of the metal grain size, when processed according to the methods described below, produces the desired mechanical properties for a vane in a gas turbine engine. In a particular embodiment, the pure metal of the nanocrystalline metal topcoat 36 is nickel (Ni) or cobalt (Co), such as for example Nanovate™ nickel or cobalt (trademark of Integran Technologies Inc.) respectively, although other metals can alternately be used, such as for example copper (Cu) or one of the above-mentioned metals. The nanocrystalline metal topcoat 36 is intended to be a pure nano-scale Ni, Co, Cu, etc. and is purposely not alloyed to obtain specific material properties. It is to be understood that the term “pure” is intended to include a metal perhaps comprising trace elements of other components but otherwise unalloyed with another metal.

In a particular embodiment, the topcoat 36 of the nose cone 22 is a plated coating, i.e. is applied through a plating process in a bath, to apply a fine-grained metallic coating to the article, such as to be able to accommodate complex vane geometries with a relatively low cost. Any suitable coating process can be used, such as for instance the plating processes described in U.S. Pat. Nos. 5,352,266 issued Oct. 4, 1994; 5,433,797 issued Jul. 18, 1995; 7,425,255 issued Sep. 16, 2008; 7,387,578, issued Jun. 17, 2008; 7,354,354 issued Apr. 8, 2008; 7,591,745 issued Sep. 22, 2009; 7,387,587 B2 issued Jun. 17, 2008; and 7,320,832 issued Jan. 22, 2008; the entire content of each of which is incorporated herein by reference. Any suitable number of plating layers (including one or multiple layers of different grain size, and/or a larger layer having graded average grain size and/or graded composition within the layer) may be provided. The nanocrystalline metal material(s) used for the topcoat layer 36 of the nose cone 22 described herein may also include the materials variously described in the above-noted patents, namely in U.S. Pat. No. 5,352,266, U.S. Pat. No. 5,433,797, U.S. Pat. No. 7,425,255, U.S. Pat. No. 7,387,578. U.S. Pat. No. 7,354,354, U.S. Pat. No. 7,591,745, U.S. Pat. No. 7,387,587 and U.S. Pat. No. 7,320,832, the entire content of each of which is incorporated herein by reference.

In an alternate embodiment, the metal topcoat layer 36 may be applied to the inner layer 34 of the nose cone 22 using another suitable application process, such as by vapour deposition of the pure metal coating, for example. In this case, the pure metal coating may be either a nanocrystalline metal as described above or a pure metal having larger scale grain sizes.

If the inner layer 34 of the nose cone 22 is formed of a non-metallic and/or a non-conductive material, such as a composite, polymer, plastic or otherwise, it may be rendered conductive if desired or required, for example by coating an outer surface of the inner layer 34 with a thin layer of silver, nickel, copper or by applying a conductive epoxy or polymeric adhesive materials prior to applying the coating layer(s). Additionally, the non-conductive substrate may be rendered suitable for electroplating by applying such a thin layer of conductive material, such as by electroless deposition, physical or chemical vapour deposition, etc.

In another aspect, the molecules comprising the surface of the nanocrystalline metal topcoat 36 on the nose cone 22 may be manipulated on a nanoscale to affect the topography of the final surface to improve the hydrophobicity (i.e. ability of the surface to resist wetting by a water droplet) to thereby provide the nose cone with a superhydrophobic, self-cleaning surface, as described in further detail above. This may beneficially reduce the need for anti-icing measures on the stator, and may also keep the airfoil cleaner, such that the need for a compressor wash of the airfoil is reduced.

The nanocrystalline metal outer layer 36 may be composed of a pure Ni and is purposely not alloyed to obtain specific material properties. The manipulation of the pure Ni grain size helps produce the required mechanical properties. The topcoat layer 36 may be a pure nickel (Ni), cobalt (Co), or other suitable metal, such as Ag, Al, Au, Cu, Cr, Sn, Fe, Mo, Pt, Ti, W, Zn or Zr and is purposely pure (i.e. not alloyed with other elements) to obtain specific material properties sought herein. In a particular embodiment, the pure metal of the nanocrystalline topcoat is nickel or cobalt, such as for example Nanovate™ nickel or cobalt (trademark of Integran Technologies Inc.) respectively, although other metals can alternately be used, such as for example copper.

Hence, it has been found that nose cones for aero turbofan gas turbine engines may be provided using a bi-material, or at least bi-layer, construction whereby an inner or underlying first layer 34 is coated by a stronger nanocrystalline metal outer coating 36, which may result in a significant weight and cost advantage, without sacrificing any strength or FOD containment capabilities, compared to a comparable more traditional aluminum, steel or other all-metal nose cone typically used in gas turbine engines. Accordingly, the construction results in a nose cone that may be cheaper to produce and more lightweight than traditional nose cones, be they solid metal or otherwise, while nevertheless providing comparable strength and other structural properties, and therefore comparable if not improved life-span.

The nanocrystalline topcoat applied to the nose cone thereby may provide improved resistance to foreign object damage (FOD) and erosion in comparison with known all-metal nose cone constructions, and therefore as a result reduced field maintenance of the gas turbine engine may be possible, as well as increased time between overhauls (TBO).

A nose cone 22 in accordance with the present disclosure, namely having an inner core or layer 34 and a nanocrystalline metal coating layer 36 on at least a portion thereof, permits an overall nose cone 22 that is between 10 and 50% lighter than a conventional solid aluminum nose cone of the same size. Further, while being more lightweight than a comparable solid nose cone, the present “hybrid” nose cone allows for reduced permanent deflections due to ice and similar FOD impact, by a factor of between 2 to 20 in comparison with a solid aluminum nose cone. Further, the surface texture and/or super-hydrophobic outer surface formed on the nose cone 22 by the outer nanocrystalline metal layer 36 helps to prevent the build up of ice on the outer surface of the nose cone, which thereby results in improved anti-icing properties of the nose cone 22. This may avoid the need to bleed any engine air for anti-icing purposes, thereby improving engine performance and reducing specific fuel consumption. This surface texture on the nanocrystalline outer layer 36 of the nose cone 22 may also reduce the boundary layer(s), thereby reducing the aerodynamic drag produced by the nose cone 22 itself and consequently further reducing fuel consumption of the engine.

The above description is meant to be exemplary only, and one skilled in the art will recognize that changes may be made to the embodiments described without departing from the scope of the invention disclosed. For example, the nose cone may have any suitable configuration and/or shape. Any suitable manner of applying the nanocrystalline metal topcoat layer may be employed. Still other modifications which fall within the scope of the present invention will be apparent to those skilled in the art, in light of a review of this disclosure, and such modifications are intended to fall within the appended claims.

1. A nose cone for a turbofan gas turbine engine, the nose cone comprising a central tip, an outer perimeter and a substantially conical outer wall extending therebetween which encloses a cavity therewithin, the outer wall including an inner substrate layer facing the cavity and an outer layer which overlies and at least partially encloses the inner substrate layer, the outer layer being composed entirely of a nanocrystalline metal forming an outer surface of the nose cone.

2. The nose cone as defined in claim 1, wherein the outer surface of the nose cone composed of the nanocrystalline metal comprises a hydrophobic-causing topography which prevents water and ice build up on the nose cone.

3. The nose cone as defined in claim 1, wherein the outer surface of the nose cone composed of the nanocrystalline metal comprises surface texture features therein, the surface texture features reducing boundary layer thickness and therefore reducing aerodynamic drag.

4. The nose cone as defined in claim 3, wherein the surface texture features further form a hydrophobic surface which prevents water and ice build up on the nose cone.

5. The nose cone as defined in claim 1, wherein the inner substrate layer is formed of a material different from that of the outer layer.

6. The nose cone as defined in claim 1, wherein the inner substrate layer is formed of at least one of aluminum, polymer, plastic, composite and a metallic foam.

7. The nose cone as defined in claim 6, wherein the metallic foam is composed of a nanocrystalline metal.

8. The nose cone as defined in claim 1, wherein the nanocrystalline metal is a single coating layer of pure metal.

9. The nose cone as defined in claim 8, wherein the nanocrystalline metal is composed of a metal selected from the group consisting of: Ni, Co, Ag, Al, Au, Cu, Cr, Sn, Fe, Mo, Pt, Ti, W, Zn, and Zr.

10. The nose cone as defined in claim 1, wherein outer layer is a metallic coating having a thickness of between 0.0005 inch and 0.125 inch.

11. The nose cone as defined in claim 10, wherein the thickness of the metallic coating is about 0.005 inch.

12. The nose cone as defined in claim 1, wherein a thickness of the outer layer composed of the nanocrystalline metal is non-constant throughout the outer wall of the nose cone.

13. The nose cone as defined in claim 1, wherein the nanocrystalline metal has an average grain size of between 10 nm and 500 nm.

14. The nose cone as defined in claim 13, wherein the average grain size of the nanocrystalline metal is between 10 nm and 15 nm.

15. A fan assembly for a gas turbine engine comprising a plurality of fan blades substantially radially extending from a fan disk adapted to be mounted to a main engine shaft, and a nose cone mounted to the fan disk, the nose cone being as defined in claim 1.

16. A turbofan gas turbine engine comprising a fan assembly, an engine core including a compressor section, a combustor and a turbine section in serial flow communication, at least one low pressure compressor of the compressor section and at least one low pressure turbine of the turbine section being mounted to a common engine low pressure shaft, the fan assembly including a plurality of fan blades substantially radially extending from a fan disk mounted to the engine low pressure shaft and a nose cone mounted to the fan disk for rotation therewith, the nose cone having a central tip, an outer perimeter and a substantially conical outer wall extending therebetween which encloses a cavity therewithin, the outer wall including an inner substrate layer facing the cavity and an outer layer which overlies and at least partially encloses the inner substrate layer, the outer layer being composed entirely of a nanocrystalline metal forming an outer surface of the nose cone.

17. A method of manufacturing a nose cone for a gas turbine engine, the method comprising the steps of:
providing an outer wall of the nose cone composed of an inner substrate layer formed of a first material; and
applying a nanocrystalline metal coating over at least a portion of the inner substrate layer of the outer wall of the nose cone, the nanocrystalline metal coating forming an outer surface of the nose cone.

18. The method as defined in claim 17, further comprising providing the nanocrystalline metal coating which forms the outer surface of the nose cone with a hydrophobic-causing topography which prevents water and ice build up on the nose cone.

19. The method as defined in claim 17, further comprising forming the inner substrate layer of the outer wall of the nose cone out of the first material, said first material comprising at least one of aluminum, polymer, plastic, composite and metallic foam.

20. The method as defined in claim 17, wherein the step of applying further comprises plating the nanocrystalline metal coating onto the inner substrate layer.
